(19) United States
(12) Patent Application Publication
(10) Pub. No.: US 2008/0068768 A1
(43) Pub. Date: Mar. 20, 2008

(54) Power Supply Device for Enhancing Power Transforming Efficiency

(76) Inventors: Wen-Hung Wu, Taipei City (TW); Chia-Hsin Tsai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/564,849

(22) Filed: Nov. 30, 2006

(30) Foreign Application Priority Data
Sep. 18, 2006 (CN) 200610154244.0

(51) Int. Cl. H02H 7/04

(52) U.S. Cl. 361/38

(57) ABSTRACT

A power supply device is utilized for providing operating voltages to circuits of various processes. Said power supply device provides a direct couple path whenever the voltage supply level of a corresponding battery enters into a domain of an operating voltage of a circuit. When the voltage provided by the battery is higher than an ideal operating voltage domain of the circuit, said power supply device utilizes a conventional transformer to supply a required voltage for said circuit. However, when the voltage provided by the battery enters the ideal operating voltage region, the power supply device provides a direct couple path for enabling said battery to directly supply a required voltage for said circuit other than supplying the required voltage by transformation of said transformer. By this mechanism, power consumption generated by the conventional transformer is saved, and related voltage utilization efficiency is enhanced.

### BACKGROUND OF THE INVENTION

1. Field of the Invention

The present invention relates to a power supply device, and more particularly, to a power supply device for enhancing power transforming efficiency.

2. Description of the Prior Art

A conventional electronic device, which has a small size and requires a battery for maintaining its operations, for example, a cell phone, has to perform a power transformation for boosting or lowering an electrical level of the battery so that the boosted or lowered electrical levels may meet various operating requirements of circuits fabricated with various processes. Therefore, a power source having a transformer is required by such small electronic device for meeting requirements of circuits having various fabrication processes or various degrees of power consumption inside said electronic device.

Please refer to FIG. 1, which illustrates a conventional power supply device 100 for supplying power for circuits of various fabrication processes. As shown in FIG. 1, the power supply device 100 comprises a battery 102, a power transforming circuit 104, a first circuit 106, and a second circuit 108. The power transforming circuit 104 comprises a first transformer 110 and a second transformer 112. Both input terminals of the first transformer 110 and the second transformer 112 are coupled to an output terminal of the battery 102 for receiving a first voltage outputted by the battery 102. The first transformer 110 is utilized for transforming the first voltage into a second voltage for supplying the first circuit 106, which may merely be operated with said second voltage. The second transformer 112 is utilized for transforming the first voltage into a third voltage for supplying the second circuit 108, which may merely be operated with said third voltage. In FIG. 1, suppose that the process of the second circuit 108 is more delicate than the first circuit 106, therefore, an operating voltage of the first circuit 106 is higher than an operating voltage of the second circuit 108. It indicates that the second voltage is higher than the third voltage, and therefore, a voltage-boosting ratio of the first transformer 110 must be higher than a voltage-boosting ratio of the second transformer 112.

For a conventional power supply device, an operating domain of the second circuit 108 may be partially overlapped with a voltage-supply domain of the battery 102. For example, a first voltage supplied by the battery 102 may range from 1.1 volts to 1.6 volts. The first circuit 106 may be a circuit utilizing a 0.18 μm process with an operating voltage of about 3.3 volts. The second circuit 108 may be a circuit utilizing a 0.13 μm process with an operating voltage ranging from 1.2 volts to 1.8 volts. Therefore, an overlapped region formed by a supply voltage and the operating voltage of the second circuit 108 lies on between 1.2 volts and 1.6 volts. In fact, although the first transformer 110 and the second transformer 112 increases (or decreases) the first voltage as high as the second voltage and the third voltage respectively, the first transformer 110 and the second transformer 112 consume abundant electricity supplied by the battery 102 during the voltage transformation because of intrinsic properties of both of the first transformer 110 and the second transformer 112. Therefore, received electricity of both of the first transformer 110 and the second transformer 112 is significantly smaller than supplied electricity from the battery 102. Moreover, since an electrical level outputted by the battery is gradually decreased while electricity is continuously supplied by the battery 102, the third voltage, which is transformed from the first voltage, is gradually decreased also. When the third voltage is decreased below a threshold voltage that the battery 102 may supply directly, unnecessary power consumption is generated by the voltage transformation of the second transformer 112 since the operating voltage domain of the second circuit 108 includes a voltage domain below the threshold voltage partially. In the example, the threshold voltage may be 1.5 volts, or any voltage between 1.1 volts and 1.6 volts, depending on the supplied voltage from the battery 102 and on the intrinsic properties of the second circuit 108.

### SUMMARY OF THE INVENTION

The claimed invention provides a power supply device for enhancing power transforming efficiency. The power supply device comprises a battery for supplying a first voltage, a power transforming circuit having an input terminal coupled to the battery, a multiplexer, and a comparator. The power transforming circuit comprises a first transformer for transforming the first voltage into a second voltage, and a second transformer for transforming the first voltage into a third voltage. The multiplexer comprises a first input terminal coupled to the second transformer for receiving the third voltage, a second input terminal coupled to the battery for receiving the first voltage, a control terminal, and an output terminal for coupling to the first input terminal or to the second input terminal according to a select signal inputted into the control terminal. The comparator comprises a first input terminal coupled to the battery, a second input terminal for inputting a default electrical level, and an output terminal coupled to the control terminal of the multiplexer. The comparator is utilized for comparing the first voltage with the default electrical level to generate the select signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional power supply device for supplying power for circuits of various fabrication processes.

FIG. 2 illustrates a plot of a discharging curve of a battery operated with a current of 140 mA.

FIG. 3 illustrates plots of discharging curves of the battery mentioned in FIG. 2 while said battery is operated with currents of 700 mA and 1400 mA respectively.

FIG. 4 is a diagram of a power supply device of the present invention.

### DETAILED DESCRIPTION

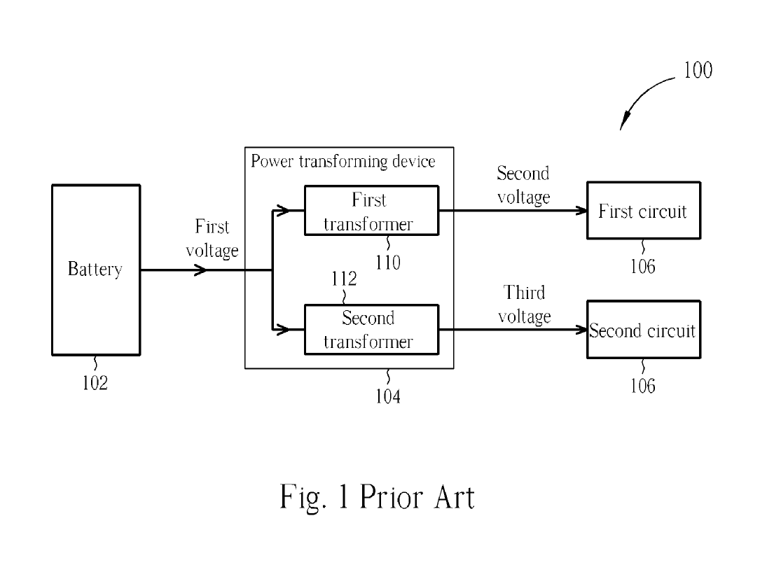

As described above, an overlapped region is formed below a threshold voltage by a supply voltage domain of a battery and by an operating voltage domain of a circuit supplied by said battery. When the battery supplies electricity within the overlapped region, unnecessary power consumption is generated instead of being stored in said battery for shortening an electricity-supplying cycle of said battery. Therefore, a power supply device of adding a direct couple path from the battery 102 to the second circuit 108 shown in FIG. 1 is provided in the present invention. With the power supply device, the battery 102 may direct supply electricity for the second circuit 108 within the overlapped region instead of generating the abovementioned unnecessary power consumption, and the second circuit 108 may remain being operated under its operating voltage domain, for increasing a power transformation efficiency of a conventional power supply device.

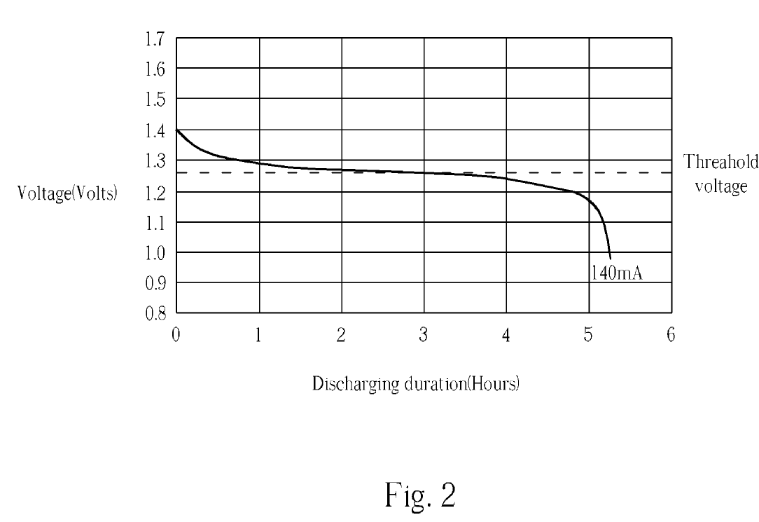

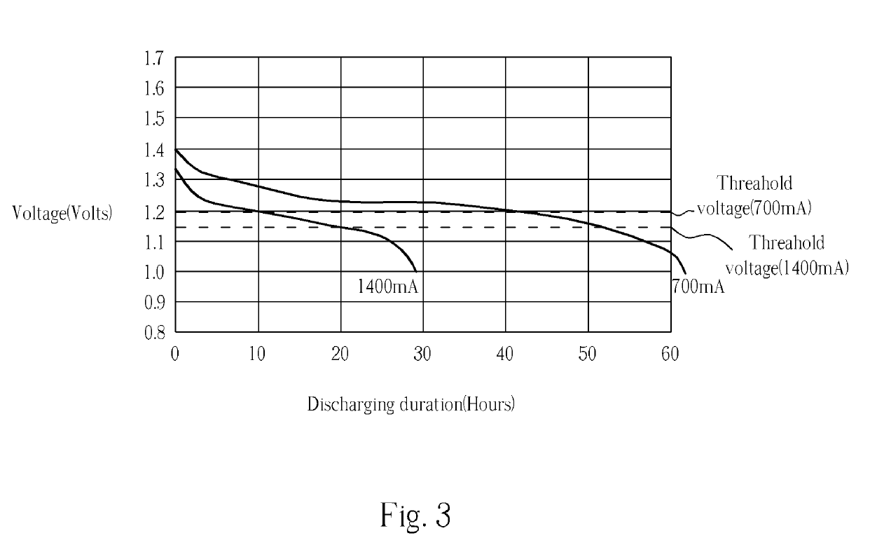

Please refer to FIG. 2 and FIG. 3. FIG. 2 illustrates a plot of a discharging curve of a battery operated with a current of 140 mA. FIG. 3 illustrates plots of discharging curves of the battery mentioned in FIG. 2 while said battery is operated with currents of 700 mA and 1400 mA respectively. As illustrated in FIG. 2 and FIG. 3, when a voltage of the battery is below a threshold voltage, which is shown respectively in FIG. 2 and FIG. 3 corresponding to the abovementioned currents of 140 mA, 700 mA, and 1400 mA, a falling slope of the discharging curve is getting large. At this time, if a transformer is still utilized for transforming a voltage outputted from the battery, additional power consumption is generated so that a power supplying cycle of said battery is shortened at a higher rate. Therefore, in the present invention, a property that a domain below the threshold voltage may be utilized for supplying a circuit having a more delicate process is utilized for preventing an additional power consumption generated from the transformer. Note that the threshold voltage described above is not limited to the values of threshold voltages shown in FIG. 2 and FIG. 3, and moreover, the value of said above-described threshold voltage might be chosen optionally so that electricity stored in the battery may be adequately utilized without generating the additional power consumption from the transformer.

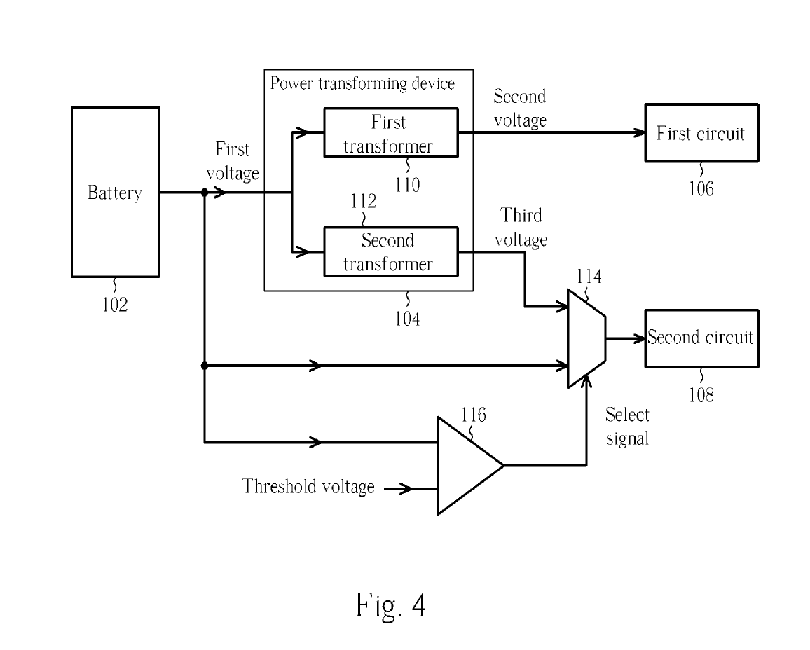

Please refer to FIG. 1 and FIG. 4 simultaneously. FIG. 4 is a diagram of a power supply device 200 of the present invention. Components of the power supply device 200 are mostly similar with the above-listed components of the power supply device 100, though the power supply device 200 further comprises a multiplexer 114 and a comparator 116 in comparison with the power supply device 100. An output terminal of the second transformer 112 is coupled to a first input terminal of the multiplexer 114 for receiving the third voltage. A second input terminal of the multiplexer 114 is coupled to the battery 102 for receiving the first voltage. An output terminal of the multiplexer 114 is selectively coupled to the first input terminal or to the second input terminal of the multiplexer 114 according to a select signal, and is also coupled to the input terminal of the second circuit 108 for supplying a voltage from said first terminal or from said second terminal of the multiplexer 114 for the second circuit 108. A first input terminal of the comparator 116 is coupled to the battery 102 for receiving the first voltage. A second input terminal of the comparator 116 is coupled to a default voltage, which is the previous-described threshold voltage. Therefore, a value of the default voltage depends on both a type of the battery 102 and properties of the second circuit 108. The value of the default voltage may also be optionally determined. Note that the comparator 116 may be replaced by other programmable comparators capable of implementing the same functions with functions of the comparator 116, and such replacements should not be limitations to the present invention. In the present invention, each of the first transformer 110 and the second transformer 112 may be a voltage-boosting transformer or a voltage-reductive transformer.

As mentioned before, the second circuit 108 is more delicate in process than the first circuit 106, and therefore, an operating voltage of the first circuit 106 is also higher than an operating voltage of the second circuit 108. That is, the second voltage is higher than the third voltage. The operating voltage of the first circuit 106 may be a high voltage that the battery 102 cannot supply, and therefore, the first voltage has to be raised into the second voltage capable of operating the first circuit 106 through the first transformer 110. The domain of the operating voltage of the second circuit 108 is partially overlapped with the supplying domain of the battery 102, i.e., a part of the domain of the operating voltage below the threshold voltage. Therefore in the present invention, when the third voltage is higher than the threshold voltage, the second transformer 112 transforms the first voltage supplied by the battery 102 into the third voltage. And when the third voltage falls off the threshold voltage, the battery 102 is responsible for supplying the second circuit 108 directly for saving power consumption generated from the transformation of the second transformer 112.

There are two operating modes for the power supply device 200, where one of said operating modes is a normal mode whereas the other one is a battery-directly-supply mode. Under the normal mode, the first voltage supplied by the battery 102 has not fallen off the threshold voltage. Therefore, besides the second voltage being generated from the first transformer 110 for supplying the first circuit 106 to be normally operated, the third voltage is also generated by the second transformer 112 for supplying the second circuit 108 to be normally operated. At this time, electricity provided by the battery for both of the first circuit 106 and the second circuit 108 is consumed by both of the first transformer 110 and the second transformer 112 up to a certain ratio. And moreover, under the normal mode, since the domains of operating voltages of both of the first circuit 106 and the second circuit 108 exceed a supply domain of the battery 102, both of the first transformer 110 and the second transformer 112 have to operate normally for having both of the first circuit 106 and the second circuit 108 to be operated normally. With a continuous supply of the battery 102, an electrical level of the first voltage is gradually reduced, and therefore, an electrical level of the third voltage, which is transformed from said first voltage, is reduced gradually also until it is below an electrical level of the threshold voltage so that the power supply 200 enters the battery-directly-supply mode. With the gradual reduction of the electrical level of the first voltage, the electrical level of the second voltage is gradually reduced also, but is still within a domain of operating the first circuit 106. Moreover, the first voltage supplied by the battery 102 cannot be utilized for directly supplying the first circuit 106, which has a higher domain of operating voltage, without being transformed by the first transformer 110, and therefore, the first transformer 110 is still required to operate normally for generating the second voltage to maintain operations of the first circuit 106 under the battery-directly-supply mode. For the second circuit 108, when the electrical level of the third voltage is lower than the electrical level of the threshold voltage, unnecessary power consumption from the second transformer 112 is generated while the third voltage is generated by continuously utilizing the second transformer 112 for supplying the second circuit 108. And therefore, in the power supply device 200, when the third voltage is lower than the threshold voltage, the comparator 116 generates a select signal and transmits said select signal to a control terminal of the multiplexer 114 for having the output terminal of the multiplexer 114, which is coupled to the first input terminal of the multiplexer 114 under the normal mode, be coupled to the second input terminal of the multiplexer 114. It indicates that the second circuit 108, which is previously supplied by the third voltage generated from the second transformer 112 under the normal mode, is now supplied by the first voltage from the battery 102 directly under the battery-directly-supply mode for preventing unnecessary power consumption generated from the second transformer 112. Since the second circuit 108 is directly supplied with electricity by the battery 102 through a switching of the multiplexer 114, it indicates that a direct couple path is generated from the battery 102 to the second circuit 108.

Though the power supply device of the present invention is primarily applied on a circuit having a more delicate process and on another circuit having a less delicate process, for example, a circuit of 0.18 μm process and another circuit of 0.13 μm process, said circuit having a less delicate process may also be replaced by another circuit, which can be supplied with electricity by a battery directly to be operated. That is, as long as an operating voltage of a circuit may be supplied by a battery in the power supply device of the present invention, the abovementioned direct couple path may be utilized on said circuit. It indicates that the direct couple path is not merely applied on a combination of a circuit having a more delicate process and another circuit having a less delicate process, but also on more than two circuits capable of being supplied with electricity directly by a battery. Note that circuits applied with the power supply device of the present invention are not limited to properties described above, and therefore, any replacement or any combination of said circuits relating to various processes or to various numbers of said circuits for the power supply device of the present invention should not be limitations to the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power supply device for enhancing power transforming efficiency comprising:
a battery for supplying a first voltage;
a power transforming circuit having an input terminal coupled to the battery, the power transforming circuit comprising:
a first transformer for transforming the first voltage into a second voltage; and
a second transformer for transforming the first voltage into a third voltage;
a multiplexer comprising:
a first input terminal coupled to the second transformer for receiving the third voltage;
a second input terminal coupled to the battery for receiving the first voltage;
a control terminal; and
an output terminal for coupling to the first input terminal or to the second input terminal according to a select signal inputted into the control terminal; and
a comparator comprising:
a first input terminal coupled to the battery;
a second input terminal for inputting a default electrical level; and
an output terminal coupled to the control terminal of the multiplexer;
wherein the comparator is utilized for comparing the first voltage with the default electrical level to generate the select signal.

2. The power supply device of claim 1 wherein the first transistor of the power transforming circuit is coupled to a first circuit so that the first circuit receives the second voltage.

3. The power supply device of claim 1 wherein the output terminal of the multiplexer is coupled to a second circuit, and a power supply domain of the battery is partially overlapped with an operating voltage domain of the second circuit.

4. The power supply device of claim 1 wherein a voltage-boosting ratio of the first transformer is larger than a voltage-boosting ratio of the second transformer.

5. The power supply device of claim 1 wherein the first transformer of the power transforming circuit is coupled to a first circuit so that the first circuit receives the second voltage; the output terminal of the multiplexer is coupled to a second circuit; and a power supply domain of the battery is partially overlapped with an operating voltage domain of the second circuit.

6. The power supply device of claim 5 wherein a process of the second circuit is more delicate than the first circuit, and power consumption of the second circuit is smaller than power consumption of the first circuit.
